(19) United States
(12) Patent Application Publication
(10) Pub. No.: US 2005/0193872 A1
(43) Pub. Date: Sep. 8, 2005

(54) System and method for attaching balusters

(76) Inventor: Marc R. Wyman, Columbus, OH (US)

Correspondence Address: ELEY LAW FIRM CO., 7870 OLENTANGY RIVER RD, SUITE 311, COLUMBUS, OH, 43235, US

(21) Appl. No.: 10/993,375

(22) Filed: Nov. 19, 2004

Related U.S. Application Data
(60) Provisional application No. 60/523,261, filed on Nov. 19, 2003.

(51) Int. Cl. B25B 13/52

(52) U.S. Cl. 81/64

(57) ABSTRACT

A system for installing a screwable baluster onto the tread of a staircase. The system comprises an engageable drive member having a tool portion for engaging a portion of the baluster having a first dimensioned shape. A wrenching means is provided for engaging the drive member and is effective to drive the baluster against the tread when operated. A method employs the system.

This application claim priority to U.S. Provisional Patent Application No. 60/523,261, file Nov. 19, 2003, the contents of which are hereby incorporated by reference.

### FIELD OF THE INVENTION

This invention relates to the attachment of balusters. In particular, this invention relates to a system and method for attaching balusters to treads of a staircase.

### BACKGROUND OF THE INVENTION

Stairs are commonly used in residences and commercial structures to provide egress between floors. A staircase typically comprises a plurality of steps with a balustrade to prevent persons and objects from falling laterally off the steps. The balustrade is comprised of a plurality of vertical support members known in the art as “balusters.” As used herein, the terms “staircase” and “stairway” may be used interchangeably and are meant to describe an assembly of multiple stair treads and their corresponding balusters and handrails.

Balusters are typically mounted between a horizontal portion or “tread” of a step and a handrail. There is typically one baluster per tread, but more can be provided if desired. Balusters are typically turned on a lathe from a square length of wood and their base is left unturned in its original square profile. Balusters are preferably attached to both the handrail at the top and the tread at the bottom. The baluster can be joined to the tread by gluing a dowel extending from the bottom of the baluster into a predrilled hole in the top of the stair or the two elements may be joined using a fully threaded dowel screw that runs vertically up into the bottom of the baluster and down into the tread. It is this latter mounting method to which the invention is addressed.

When mounting a threadable baluster to a stair tread using a dowel screw, it is desirable to join the two components as tightly as possible without damaging or marring the surface of the wooden baluster. This usually requires that the installer repeatedly rotate the baluster by hand in order to drive the dowel screw into a mating opening in the tread. The opening is typically smaller in diameter than the dowel screw so that the threads of the dowel screw form threads in the opening. A significant amount of torque is thus required to couple the baluster to the tread. Since a number of balusters are required for a typical set of stairs, an installer is at risk of at least a strenuous task or even an injury, such as chronic pain or a repetitive-stress injury.

Conventional tools, such as adjustable wrenches, may be used to provide the installer with additional leverage to ease the baluster installation process. However, these devices are ordinarily unsuitable, since they tend to mar or damage the surface of the normally unfinished baluster, making the baluster unsightly. Further, such devices may often be limited in the amount of baluster rotation they can provide, due to the close proximity of other stair components such as adjacent balusters, stair risers, and treads. This is particularly problematic when a baluster in a completed set of stairs must be removed or replaced.

There is a need for a device and method to facilitate the efficient assembly of balusters to stair treads with reduced exertion on the part of the installer. There is a further need for a device and method to facilitate the assembly of balusters without marring or damaging the balusters. There is a yet further need to provide a device and method for installing balusters in space-constrained areas.

### Summary of the Invention

According to the present invention, a device is disclosed for securing a baluster to a stair tread. The present invention comprises a generally cylindrical drive member and an attachable wrench. An outer portion of the drive member is generally round or “C-shaped,” while an interior portion comprises a cut-out generally corresponding to the shape of the base of the baluster. The wrench comprises a circular strap attached to a handle or a pair of handles. Each end of the strap is mounted at offset portions on the handle so that when the strap is placed over the drive member and the handle is rotated, the strap of the wrench will tighten and grasp the drive member.

If the drive member is fabricated as a complete round, it is placed over an unattached upper end of the baluster and positioned at the base of the baluster. The wrench is then ratcheted by moving the handle, thus turning and tightening the baluster into the stair tread in much the same manner as an oil filter wrench is used to tighten an oil filter. Once the desired tightness is attained, the wrench is removed by lifting it up and over the unattached upper end of the baluster. This embodiment of the present invention is effective for situations where the upper end of the baluster is not obstructed by a handrail or other obstacle.

Alternate embodiments of the present invention provide for a driver portion that is “C-shaped,” arranged in pivoting portions, or in separable portions. In this regard, the wrench could be applied to the base of the baluster laterally and without sliding it down from the upper end of the baluster. Once in place, the driver portion is engaged by the wrench and then reciprocated, as before, until the baluster has reached the desired tightness in relation to the stair tread.

In one aspect of the invention a device is provided for installing a screw-bearing baluster onto the tread of a staircase comprising, an engageable drive member having a tool portion for engaging a portion of the baluster having a first dimensioned shape, and a wrenching means for engaging the drive member and being effective to drive the baluster against the thread when operated.

### BRIEF DESCRIPTION OF THE DRAWINGS

Further features of the present invention will become apparent to those skilled in the art to which the present invention relates from reading the following specification with reference to the accompanying drawing, in which:

FIG. 1 is a diagrammatic view of a typical stairway;

FIG. 2 is a view of the attachment of a baluster to a stair tread;

FIG. 3A is a top plan view of a drive member according to an embodiment of the present invention;

FIG. 3B is a side elevational view of the drive member of FIG. 3A;

FIG. 4 illustrates a wrench according to an embodiment of the present invention;

FIG. 5A is a top plan view of a drive member of an alternate embodiment of the present invention;

FIG. 5B is a top plan view of a drive member of an another alternate embodiment of the present invention;

FIG. 5C is a top plan view of a drive member of an still another alternate embodiment of the present invention;

FIG. 6 shows a side elevational view of a drive member and wrench installed to a baluster according to an embodiment of the present invention; and

FIG. 7 shows a top plan view of a drive member and wrench installed to a baluster according to an embodiment of the present invention.

### DESCRIPTION OF THE PREFERRED EMBODIMENT(S)

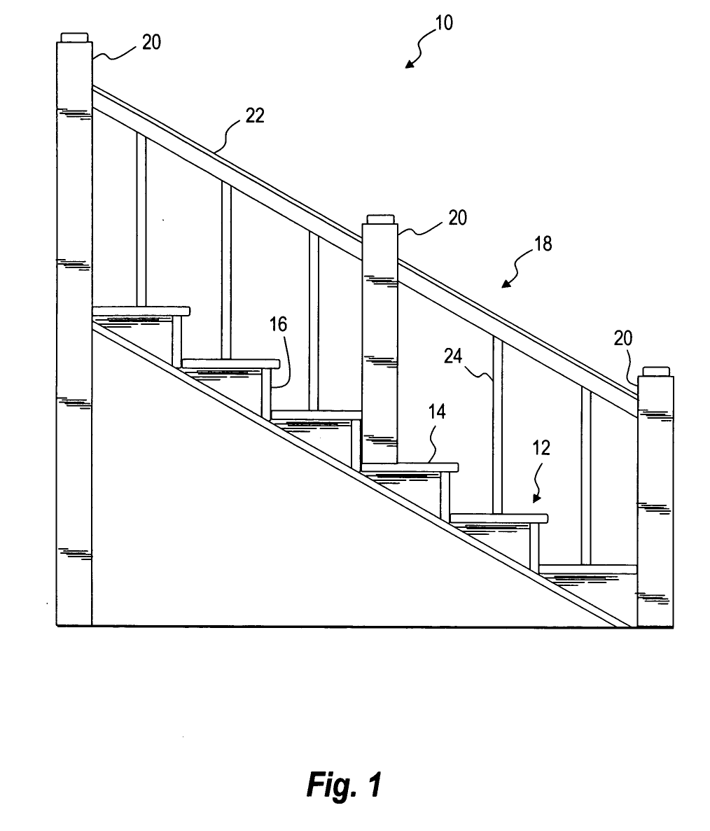

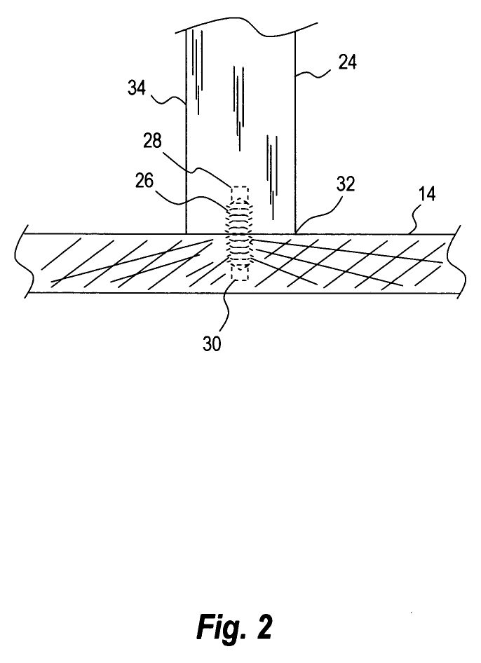

A diagram of a typical stairway 10 is shown in FIG. 1. Stairway 10 comprises a plurality of steps 12, each step having a generally horizontal tread 14 and a generally vertical riser 16. A balustrade 18 is comprised of a plurality of newels 20, a handrail 22, and a plurality of balusters 24 extending generally vertically between handrail 22 and treads 14. As shown in FIG. 2, the balusters 24 are typically secured to the treads 14 by means of a self-tapping dowel screw 26 which extends into both the tread and the baluster. Each baluster 24 is typically installed to a tread 14 by first tapping a dowel screw 26 at least partially into an under-sized opening 28 of the baluster, leaving a portion of the dowel screw protruding from the baluster. Then, the installer positions the baluster 24 proximate an under-sized opening 30 of tread 14 such that the protruding dowel screw 26 is in contact with the tread opening. The baluster 24 is then rotated clockwise to engage dowel screw 26 with opening 30, forming threads in sidewalls (not shown) of the opening. The installer rotates baluster 24 until dowel screw 26 is fully engaged with tread 14 and a bottom mating surface 32 of a lower portion 34 of the baluster is in the desired position in relation to an upper surface of tread 14.

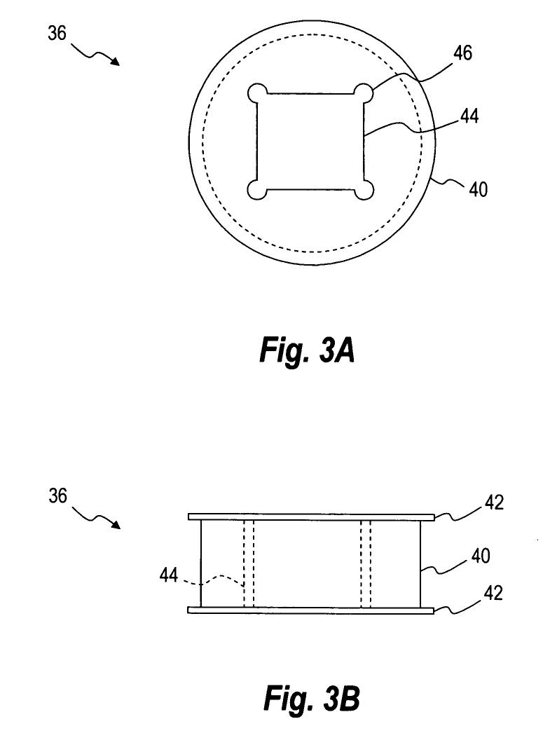

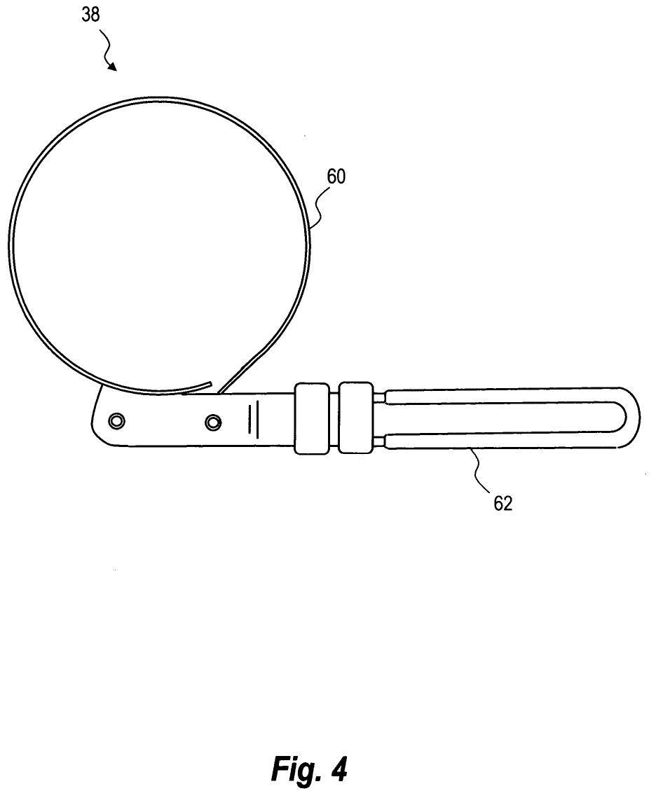

A system for installing balusters 24 onto treads 14 of a staircase 10 is comprised of an engageable drive member 36 (FIGS. 3A and 3B) and a driving means, such as a wrench 38 (FIG. 4). Wrench 38 may be a conventional strap and lever handle type wrench well-known in the art for installing and removing oil filters and other cylindrical objects. It may or may not be provided with a ratcheting drive. Drive member 36 is adapted to couple to lower portion 34 of baluster 24. Drive member 36 is further adapted to couple to wrench 38. Details of drive member 36 and wrench 38 are provided below.

A drive member 36 according to an embodiment of the present invention is shown in FIGS. 3A and 3B. Drive member 36 has a generally round outer portion 40. Outer portion 40 further comprises a pair of flanges 42 to limit undesired lateral movement of wrench 38. Drive member 36 further comprises a tool portion 44. Tool portion 44 is adapted to couple to the lower portion 34 of a baluster 24. Tool portion 44 further comprises corner reliefs 46 to allow the corners of a baluster 24 to fit easily into the tool portion. This embodiment of the present invention requires that drive member 36 be installed over an unattached top portion of a baluster 24. This embodiment is particularly useful for installation of new balustrades 18 wherein a handrail 22 has not yet been installed.

Drive member 36 may be made from any conventional material, such as metal, wood or plastic. In addition, surface portions of drive member 36 may be coated or covered with a soft or pliable material to prevent scratching or other damage to baluster 24.

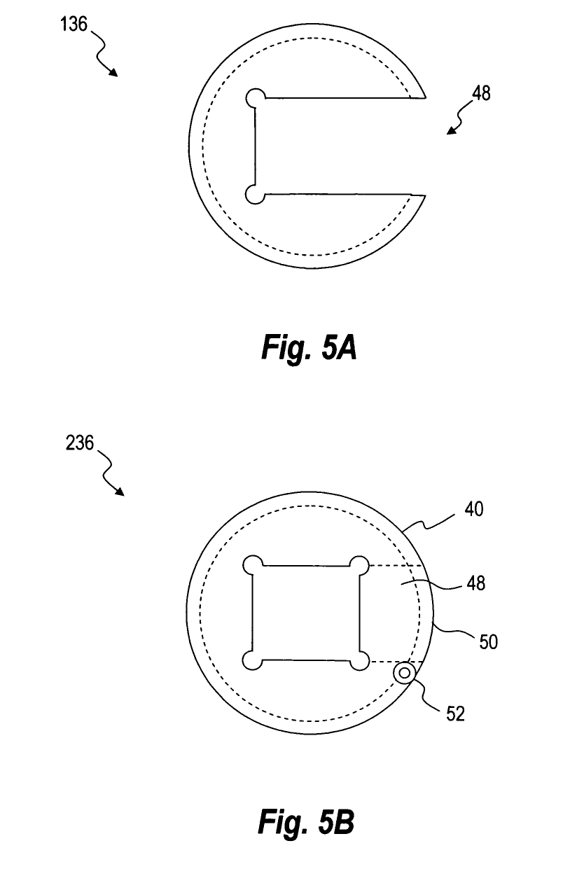

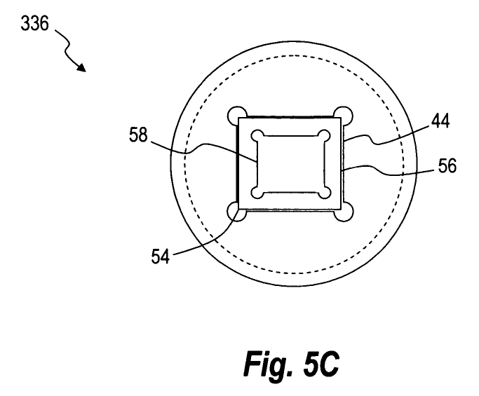

FIG. 5A depicts a first alternate embodiment of the drive member, identified as 136. Drive member 136 comprises the same general features as drive member 36, with the exception of an access opening 48. Access opening 48 is adapted to facilitate lateral installation of drive member 136 onto a baluster 24. This embodiment is particularly useful for repair and servicing of balusters of a balustrade 18 where the handrail 22 is already installed, or where the upper portion of baluster 24 is otherwise attached or inaccessible.

FIG. 5B illustrates a second alternate embodiment of the drive member, identified as 236. Drive member 236 comprises the same general features as drive member 136, with the exception of a closure 50 hingedly attached to an outer portion 40 by means of a conventional hinge member 52. Closure 50 and hinge 52 cooperate such that the closure may be opened to allow installation of the drive member 236 onto a baluster via an opening 48, then closed to engage drive member 236 with the baluster 24.

FIG. 5C shows a third alternate embodiment of the drive member, identified as 336. Drive member 336 comprises the same general features as drive member 36, with the exception of an insert 54. Insert 54 fits into tool portion 44, such as by a press fit, so that the tool portion retains the insert. An outer portion 56 of insert 54 is adapted to couple to tool portion 44, while an insert tool portion 58 is adapted to couple to a lower portion 34 of a baluster. In this embodiment of the present invention, a plurality of inserts 54 may be provided, each having an outer portion 56 adapted to couple to tool portion 44 and an insert tool portion 58 adapted to couple to at least one of various types and shapes of balusters 24, including rounds and polygons other than square.

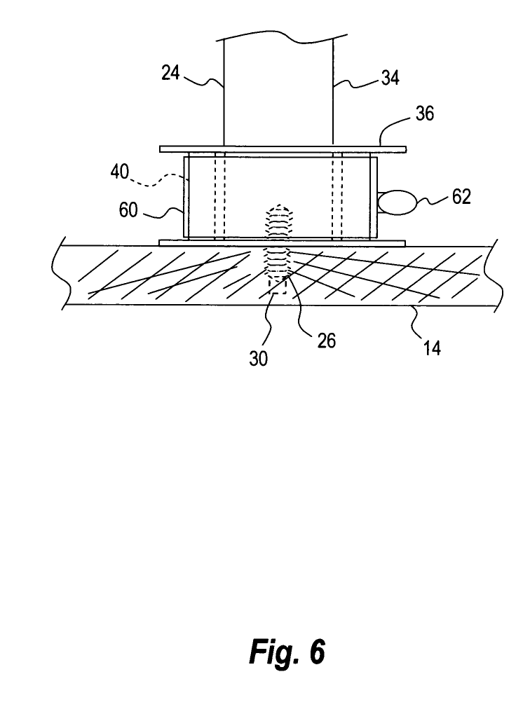

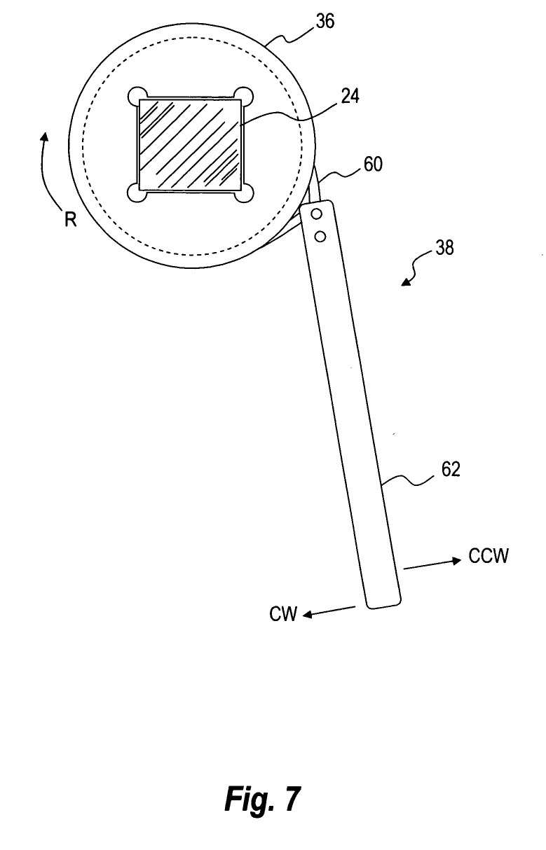

FIGS. 6 and 7 illustrate drive member 36 coupled to a lower portion 34 of a baluster 24. A strap portion 60 of wrench 38 is positioned over outer portion 40 of drive member 36. A lever handle 62 is pivoted in a clockwise direction, as depicted by arrow “CW” in FIG. 7. As handle 62 is pivoted, strap 60 tightens against outer portion 40 of drive member 40, causing drive member to rotate clockwise, as depicted by arrow “R” in FIG. 7. Since baluster 24 is captured by tool portion 44, the baluster will likewise rotate clockwise, causing dowel screw 26 to thread itself into opening 30 of tread 14. Counter-clockwise movement of handle 62 (depicted by arrow “CCW” in FIG. 7) loosens strap 60, releasing the grip of strap 60 upon drive member 36 and allowing the handle to be pivoted counter-clockwise. Regular clockwise and then counter-clockwise reciprocating motion of handle 62 as described above will cause a ratcheting action between wrench 38 and drive member 36. The mechanical advantage provided by handle 62 allows baluster 24 to be installed faster and with less effort as compared to hand-installation.

One skilled in the art will recognize that wrench 38 may be installed as a mirror-image of the arrangement of FIG. 7, facilitating a counter-clockwise ratcheting action as is well-known in the art of oil-filter wrenches. The counter-clockwise motion of drive member 36 facilitates removal of baluster 24 from tread 14 by causing dowel screw 26 to unscrew from tread 14 (see FIG. 2).

From the above description of the invention, those skilled in the art will perceive improvements, changes, and modifications in the invention. Such improvements, changes, and modifications within the skill of the art are intended to be covered.

1. A system for installing a screwable baluster onto the tread of a staircase, comprising:
an engageable drive member having a tool portion for engaging a portion of the baluster having a first dimensioned shape; and
a wrenching means for engaging the drive member and being effective to drive the baluster against the thread when operated.

2. The device of claim 1 wherein the drive member further comprises a rounded outer portion.

3. The device of claim 2 wherein the wrenching means comprises a strap and lever arrangement.

4. The device of claim 3 wherein a portion of the wrenching means is adapted to engage the outer portion of the drive member.

5. The device of claim 1 wherein the tool portion is provided with a plurality of corner reliefs.

6. The device of claim 1 wherein the drive member has opposing, generally planar surfaces.

7. The device of claim 6 wherein the opposing, planar surface comprise flanges for retaining a strap of the wrenching means in engaging contact with the rounded outer portion.

8. The device of claim 1 wherein a peripheral portion of the drive member is removed to enable the drive member to laterally engage a portion of the baluster.

9. The device of claim 8 wherein the removed peripheral portion of the drive member is covered by a hinged closure.

10. The device of claim 1 further comprising an insert adapted to fit within the tool portion, the insert being adapted to couple to a second dimensioned baluster shape.

11. A method for installing a threaded baluster onto the tread of a staircase comprising the steps of,
providing a baluster having a generally centered opening in a confronting face of its base of a first diameter;
providing a tread for a staircase having a opening of a first diameter located in a confronting face at a predetermined location;
inserting a dowel screw having a second diameter in the openings in the baluster and tread for a staircase;
engaging a dimensioned portion of the baluster within the tool portion of a drive member;
engaging the drive member with a wrenching means; and
operating the wrenching means until the confronting faces of the baluster and the staircase tread are in a desired distance from one another.
